(19) United States
(12) Patent Application Publication
(10) Pub. No.: US 2016/0247502 A1
(43) Pub. Date: Aug. 25, 2016

(54) AUDIO SIGNAL PROCESSING APPARATUS AND METHOD ROBUST AGAINST NOISE

(71) Applicant: Electronics and Telecommunications Research Institute, Daejeon (KR)

(72) Inventors: Tae Jin PARK, Daejeon (KR); Yong Ju LEE, Daejeon (KR); Seung Kwon BEACK, Seoul (KR); Jong Mo SUNG, Daejeon (KR); Tae Jin LEE, Daejeon (KR); Jin Soo CHOI, Daejeon (KR)

(21) Appl. No.: 14/817,292

(22) Filed: Aug. 4, 2015

(30) Foreign Application Priority Data
Feb. 23, 2015 (KR) 10-2015-0025372

(51) Int. Cl. G10L 15/20; G10L 15/22; G10L 21/0232

(52) U.S. Cl. CPC G10L 15/20; G10L 21/0232; G10L 15/22

(57) ABSTRACT

Provided is an audio signal processing apparatus and method that may convert a speech and audio signal to a spectrogram image, calculate a local gradient using a mask matrix from the spectrogram image, divide the local gradient into blocks of a preset size, generate a weighted histogram for each block, generate an audio feature vector by connecting weighted histograms of the blocks, generate a feature set by performing a discrete cosine transform (DCT) on a feature set of the audio feature vector, and generate an optimized feature set by eliminating an unnecessary region from the transformed feature set and reducing a size of the transformed feature set.

### CROSS-REFERENCE TO RELATED APPLICATION

This application claims the priority benefit of Korean Patent Application No. 10-2015-0025372, filed on Feb. 23, 2015, in the Korean Intellectual Property Office, the disclosure of which is incorporated herein by reference.

### BACKGROUND

1. Field of the Invention

The present invention relates to an audio signal processing apparatus and method, and more particularly, to an apparatus and a method for performing preprocessing to readily recognize a speech or audio from a speech and audio signal.

2. Description of the Related Art

Most conventional speech and audio recognition systems extract an audio feature signal based on a Mel-frequency cepstral coefficient (MFCC). The MFCC is designed to separate an influence of a path through which a speech and audio signal is transmitted by applying a concept of cepstrum based on a logarithmic operation. However, an MFCC based extraction method may be extremely vulnerable to additive noise due to a characteristic possessed by a logarithmic function. Such a vulnerability may lead to deterioration in an overall performance because incorrect information may be transferred to a backend of a speech and audio recognizer.

Thus, other feature extraction methods including a relative spectral (RASTA)-perceptual linear prediction (PLP) are suggested. However, such methods may not significantly improve a recognition rate. Thus, researches have been conducted on speech recognition in a noisy environment to actively eliminate noise using a noise elimination algorithm. However, the speech recognition in a noisy environment may not achieve a recognition rate which is achieved through recognition by human beings. The speech recognition in a noisy environment, for example, on a street and in a vehicle having a high noise level, may not achieve a high recognition rate in an actual operation despite a high recognition rate of a natural language.

Such a degradation in a recognition rate due to noise in the speech recognition may occur due to a difference between training data and test data. In general, training data sets are recorded in a clean environment without noise. When a speech recognizer is manufactured and activated based on a feature signal extracted from the training data sets, a difference between a feature signal extracted from a speech signal recorded in a noisy environment and the feature signal extracted from the training data sets may occur. The speech recognizer may not recognize a word in response to the difference exceeding an estimable range in a hidden Markov model (HMM) used for a general recognizer.

To solve such an issue described in the foregoing, multi-conditioned training, which is a method of exposing the training data sets to a noisy environment with various intensities starting from a training process, is introduced. Through the multi-conditioned training, a recognition rate in a noiseless environment may slightly decrease although a recognition rate in a noisy environment is slightly improved.

Due to such technical limitations in conventional technology, there is a desire for new technology for speech recognition in a noisy environment.

### SUMMARY

An aspect of the present invention provides an audio signal processing apparatus and method robust against noise to solve such issues described in the foregoing.

The audio signal processing apparatus and method may convert a speech and audio signal to a spectrogram image and extract a feature vector based on a gradient value of the spectrogram image.

The audio signal processing apparatus and method may compare the feature vector extracted based on the gradient value of the spectrogram image to a feature vector of training data, and recognize a speech or audio.

According to an aspect of the present invention, there is provided an audio signal processing apparatus including a receiver configured to receive a speech and audio signal, a spectrogram converter configured to convert the speech and audio signal to a spectrogram image, a gradient calculator configured to calculate, using a mask matrix, a local gradient from the spectrogram image, a histogram generator configured to divide the local gradient into blocks of a preset size and generate a weighted histogram for each block, and a feature vector generator configured to generate an audio feature vector by connecting weighted histograms of the blocks.

The apparatus may further include a recognizer configured to recognize a speech or audio included in the speech and audio signal by comparing the audio feature vector to a feature vector of prestored training data.

The apparatus may further include a discrete cosine transformer configured to generate a feature set by performing a discrete cosine transform (DCT) on a feature set of the audio feature vector.

The apparatus may further include a recognizer configured to recognize a speech or audio included in the speech and audio signal by comparing the transformed feature set to a feature set of prestored training data.

The apparatus may further include an optimizer configured to generate an optimized feature set by eliminating an unnecessary region from the transformed feature set and reducing a size of the transformed feature set.

The apparatus may further include a recognizer configured to recognize a speech or audio included in the speech and audio signal by comparing the optimized feature set to a feature set of prestored training data.

The spectrogram converter may generate the spectrogram image by performing a discrete Fourier transform (DFT) on the speech and audio signal based on a Mel-scale frequency.

According to another aspect of the present invention, there is provided a speech and audio signal processing method performed by an audio signal processing apparatus, the method including receiving a speech and audio signal, converting the speech and audio signal to a spectrogram image, calculating, using a mask matrix, a local gradient from the spectrogram image, dividing the local gradient into blocks of a preset size and generating a to weighted histogram for each block, and generating an audio feature vector by connecting weighted histograms of the blocks.

The method may further include recognizing a speech or audio included in the speech and audio signal by comparing the audio feature vector to a feature vector of prestored training data.

The method may further include generating a feature set by performing a DCT on a feature set of the audio feature vector.

The method may further include recognizing a speech or audio included in the speech and audio signal by comparing the transformed feature set to a feature set of prestored training data.

The method may further include generating an optimized feature set by eliminating an unnecessary region from the transformed feature set and reducing a size of the transformed feature set.

The method may further include recognizing a speech or audio included in the speech and audio signal by comparing the optimized feature set to a feature set of prestored training data.

The converting may include generating the spectrogram image by performing a DFT on the speech and audio signal based on a Mel-scale frequency.

According to still another aspect of the present invention, there is provided a speech and audio signal processing method performed by an audio signal processing apparatus, the method including converting a speech and audio signal to a spectrogram image, and extracting a feature vector based on a gradient value of the spectrogram image.

The method may further include recognizing a speech or audio included in the speech and audio signal by comparing the feature vector to a feature vector of prestored training data.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of an audio signal processing apparatus according to an embodiment of the present invention;

FIG. 2 is a flowchart illustrating an audio signal processing method performed by an audio signal processing apparatus according to an embodiment of the present invention;

FIG. 3 illustrates an example of a Mel-scale filter;

FIG. 4 illustrates an example process of converting a speech and audio signal to a spectrogram image according to an embodiment of the present invention;

FIG. 5 illustrates an example process of extracting a gradient from a spectrogram image according to an embodiment of the present invention;

FIG. 6 illustrates an example process of generating a weighted histogram according to an embodiment of the present invention; and

FIG. 7 illustrates an example process of performing a discrete cosine transform (DCT) on a feature set for optimization according to an embodiment of the present invention.

### DETAILED DESCRIPTION

Reference will now be made in detail to example embodiments of the present invention, examples of which are illustrated in the accompanying drawings, wherein like reference numerals refer to the like elements throughout. Example embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the example embodiments of the present invention and thus may be changed depending on a user, the intent of an operator, or a custom. Accordingly, the terms must be defined based on the following overall description of this specification.

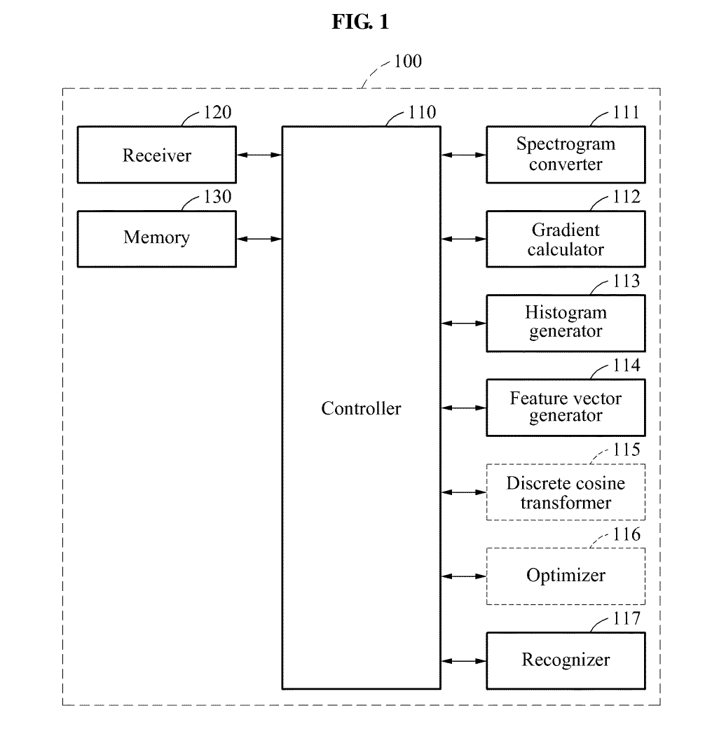

Hereinafter, an audio signal processing apparatus and method robust against noise will be described in detail with reference to FIGS. 1 through 7.

FIG. 1 is a diagram illustrating a configuration of an audio signal processing apparatus 100 according to an embodiment of the present invention.

Referring to FIG. 1, the audio signal processing apparatus 100 includes a controller 110, a receiver 120, a memory 130, a spectrogram converter 111, a gradient calculator 112, a histogram generator 113, a feature vector generator 114, a discrete cosine transformer 115, an optimizer 116, and a recognizer 117. Here, the discrete cosine transformer 115 and the optimizer 116 may be omitted.

The receiver 120 receives a speech and audio signal. The receiver 120, provided in a form of a microphone, may receive a speech and audio signal through data communication, or collect a speech and audio signal.

The memory 130 stores training data to recognize a speech or audio.

The spectrogram converter 111 converts the speech and audio signal to a spectrogram image.

The spectrogram converter 111 generates the spectrogram image by performing a discrete Fourier transform (DFT) on the speech and audio signal based on a Mel-scale frequency.

A Mel-scale is expressed as Equation 1.

f[k]=700(10^{m[k]/2595}−1) [Equation 1]

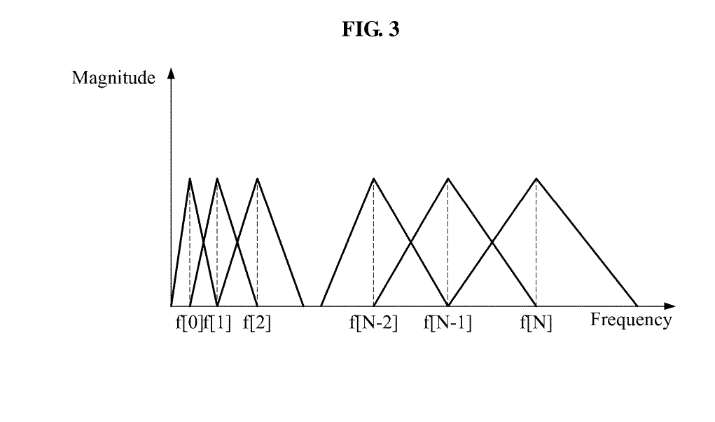

In Equation 1, “k” denotes the number of a frequency axis as illustrated in FIG. 3, and “f[k]” and “m[k]” denote a frequency and a Mel-scale number, respectively.

FIG. 3 illustrates an example of a Mel-scale filter.

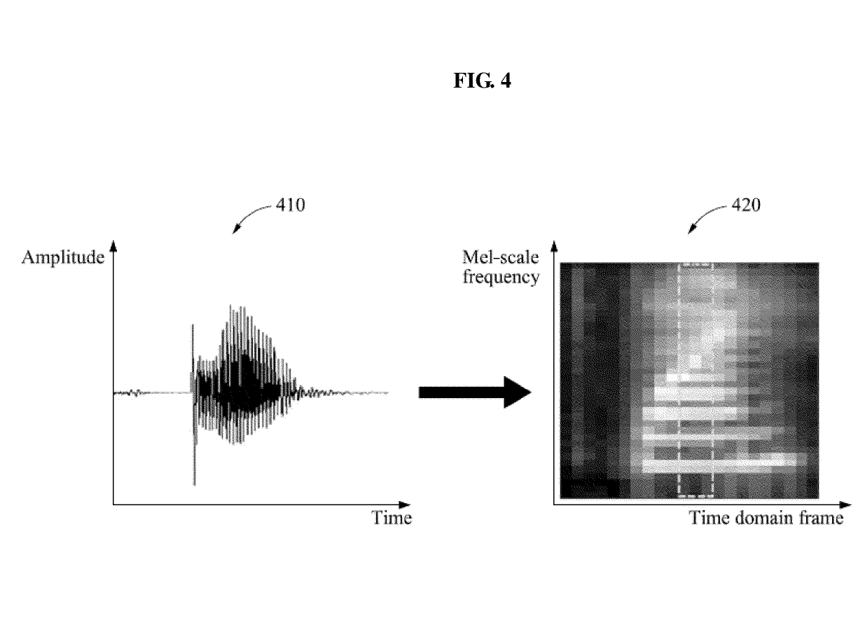

FIG. 4 illustrates an example process of converting a speech and audio signal to a spectrogram image according to an embodiment of the present invention.

Referring to FIG. 4, the spectrogram converter 111 of FIG. 1 may convert a speech and audio signal 410 to a spectrogram image 420 by performing a DFT using the Mel-scale expressed as in Equation 1.

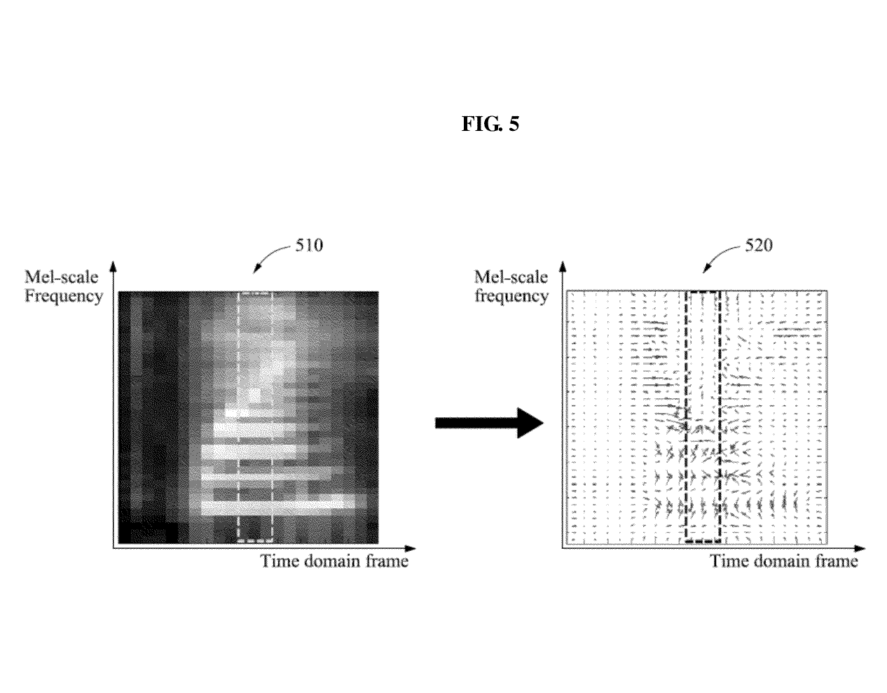

The gradient calculator 112 of FIG. 1 may calculate, using a mask matrix, a local gradient from a spectrogram image, as illustrated in FIG. 5.

FIG. 5 illustrates an example process of extracting a gradient from a spectrogram image according to an embodiment of the present invention.

Referring to FIG. 5, the gradient calculator 112 of FIG. 1 may calculate a local gradient 520 from a spectrogram image 510 using a mask matrix as in Equation 2.

g=[−1,0,1] [Equation 2]

In Equation 2, “g” denotes a mask matrix, and passes a two-dimensional (2D) convolution operation as in Equation 3.

dT=g [symbol] M

dF=−g^{T} [symbol] M [Equation 3]

In Equation 3, “ [symbol] ” denotes a 2D convolution operation, and “dT” and “dF” denote a matrix including a gradient in a time axis direction and a matrix including a gradient in a frequency axis direction, respectively. “M” denotes an original spectrogram image obtained through a Mel-scale.

As in Equation 4, an angle matrix “θ(t,f)” and a gradient magnitude matrix) “A(t,f)” may be obtained using the matrices dT and dF.

$$θ ( t , f ) = arctan ( \frac{d F ( t , f )}{d T ( t , f )} ) \\ A ( t , f ) = \sqrt{d {F ( t , f )}^{2} + d {T ( t , f )}^{2}} \qquad [ Equation 4 ]$$

In Equation 4, “θ(t, f)” and “A(t, f)” denote an angle matrix and a gradient magnitude matrix, respectively. “t” and “f” denote a time axis (horizontal axis) index value and a frequency axis (vertical axis) index value, respectively.

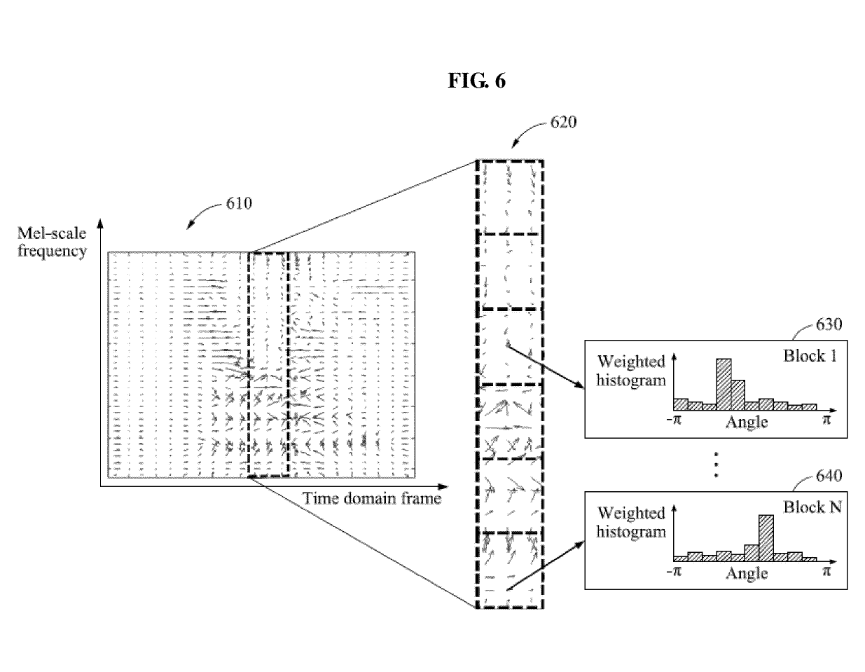

FIG. 6 illustrates an example process of generating a weighted histogram according to an embodiment of the present invention.

Referring to FIG. 6, the histogram generator 113 of FIG. 1 may divide a local gradient 620 of a gradient 610 into blocks of a preset size, and generate weighed histograms, for example, a weighted histogram 630 and a weighted histogram 640, for each block.

The histogram generator 113 may generate a weighted histogram as in Equation 5 using the two matrices θ(t, f) and A(t, f) generated as in Equation 4.

$$h ( i ) = {\sum }_{θ ( t , f ) ∈ B ( i )} A ( t , f ) \qquad [ Equation 5 ]$$

In Equation 5, “h(i)” denotes a weighted histogram, and “B(i)” denotes a set obtained by dividing an angle into eight levels, from 0° to 360°.

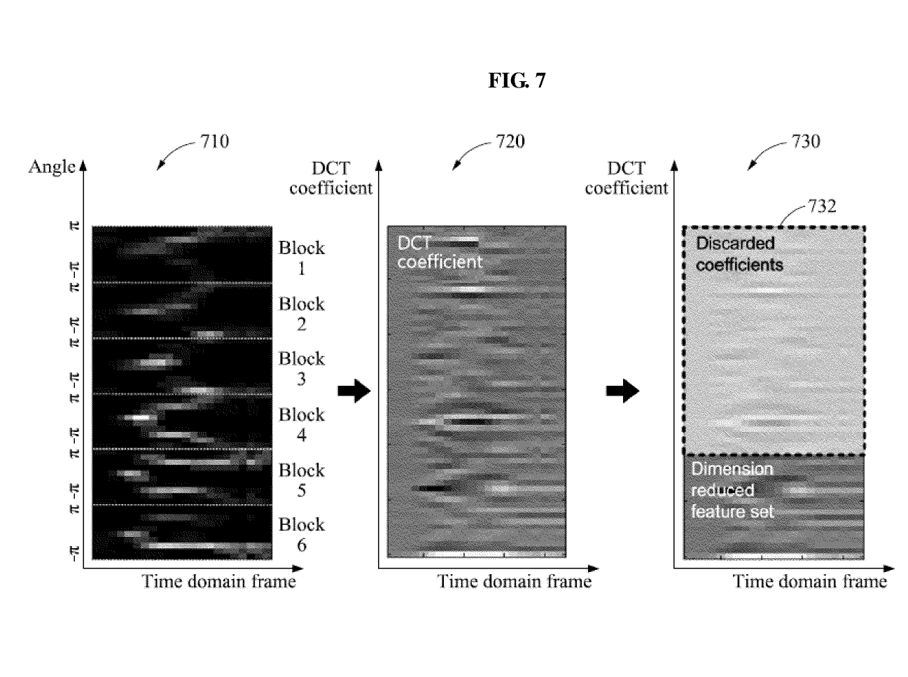

The feature vector generator 114, the discrete cosine transformer 115, and the optimizer 116 of FIG. 1 will be described with reference to FIG. 7.

FIG. 7 illustrates an example process of performing a discrete cosine transform (DCT) on a feature set for optimization according to an embodiment of the present invention.

Referring to FIG. 7, the feature vector generator 114 may generate audio feature vectors by connecting weighted histograms of blocks.

In a weighted histogram, sets of data in a y axis may have a strong correlation and thus, a recognition performance may deteriorate when the data is input to a hidden Markov model (HMM). Thus, performing a DCT may be necessary to increase the recognition performance by reducing such a correlation and simultaneously reducing a size of a feature vector.

The discrete cosine transformer 115 may generate a feature set 720 by performing a DCT on a feature set 710 which is a set of the audio feature vectors.

The optimizer 116 may generate an optimized feature set 730 by eliminating an unnecessary region 732 from the feature set 720 and reducing a size of the feature set 720.

Here, the unnecessary region 732 may correspond to high coefficients among DCT coefficients, and may not make a great change in a speech feature although being discarded and may degrade a recognition rate. Thus, a recognition rate may be improved by discarding the coefficients.

In a case that the discrete cosine transformer 115 and the optimizer 116 are omitted, the recognizer 117 may recognize a speech or audio included in a speech and audio signal by comparing a feature vector to a feature vector of prestored training data.

In a case that the optimizer 116 is omitted, the recognizer 117 may recognize a speech or audio included in a speech and audio signal by comparing a transformed feature set to a feature set of prestored training data.

In a case that both the discrete cosine transformer 115 and the optimizer 116 are included in the audio signal processing apparatus 100, the recognizer 117 may recognize a speech or audio included in a speech and audio signal by comparing an optimized feature set generated by the optimizer 116 to a feature set of prestored training data.

The controller 110 may control an overall operation of the audio signal processing apparatus 100. In addition, the controller 110 may perform functions of the spectrogram converter 111, the gradient calculator 112, the histogram generator 113, the feature vector generator 114, the discrete cosine transformer 115, the optimizer 116, and the recognizer 117. The division and configuration of the audio signal processing apparatus 100 into the controller 110, the spectrogram converter 111, the gradient calculator 112, the histogram generator 113, the feature vector generator 114, the discrete cosine transformer 115, the optimizer 116, and the recognizer 117 are provided to describe the functions individually. Thus, the controller 110 may include at least one processor configured to perform individual functions of the spectrogram converter 111, the gradient calculator 112, the histogram generator 113, the feature vector generator 114, the discrete cosine transformer 115, the optimizer 116, and the recognizer 117. Alternatively, the controller 110 may include at least one processor configured to perform a portion of the individual functions of the spectrogram converter 111, the gradient calculator 112, the histogram generator 113, the feature vector generator 114, the discrete cosine transformer 115, the optimizer 116, and the recognizer 117.

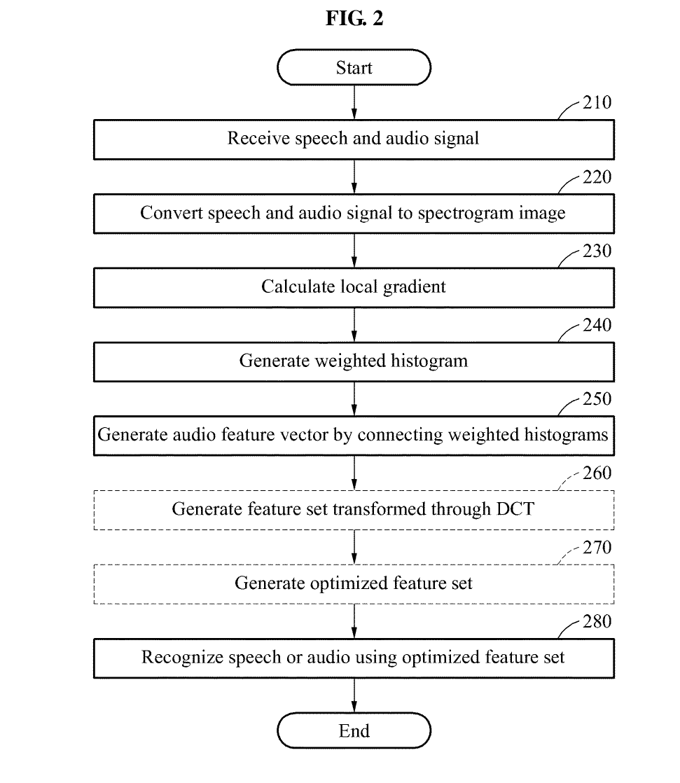

Hereinafter, an audio signal processing method robust against noise will be described with reference to FIG. 2.

FIG. 2 is a flowchart illustrating the audio signal processing method performed by the audio signal processing apparatus 100 according to an embodiment of the present invention.

Referring to FIG. 2, in operation 210, the audio signal processing apparatus 100 receives a speech and audio signal.

In operation 220, the audio signal processing apparatus 100 converts the speech and audio signal to a spectrogram image.

In operation 230, the audio signal processing apparatus 100 calculates, using a mask matrix, a local gradient from the spectrogram image.

In operation 240, the audio signal processing apparatus 100 divides the local gradient into blocks of a preset size, and generates a weighted histogram for each block.

In operation 250, the audio signal processing apparatus 100 generates an audio feature vector by connecting weighted histograms of the blocks.

In a case that operations 260 and 270 to be described hereinafter are omitted, in operation 280, the audio signal processing apparatus 100 recognizes a speech or audio included in the speech and audio signal by comparing the audio feature vector to a feature vector of prestored training data.

In a case that operation 260 is not omitted, in operation 260, the audio signal processing apparatus 100 generates a feature set transformed by performing a DCT on a feature set of the audio feature vector.

In a case that operation 270 is omitted, in operation 280, the audio signal processing apparatus 100 recognizes a speech or audio included in the speech and audio signal by comparing the transformed feature set to a feature set of prestored training set.

In a case that operations 260 and 270 are not omitted, in operation 270, the audio signal processing apparatus 100 generates an optimized feature set by eliminating an unnecessary region from the transformed feature set and reducing a size of the transformed feature set.

In operation 280, the audio signal processing apparatus 100 recognizes a speech or audio included in the speech and audio signal by comparing the optimized feature set to a feature set of prestored training data.

According to example embodiments, an audio signal processing apparatus and method may use a feature vector extracted based on a gradient value of a spectrogram image converted from a speech and audio signal. The audio signal processing apparatus and method based on a gradient value may extract an angle and a size as a feature using gradient values in both directions, for example, a time axis and a frequency axis, and thus, may be robust against noise and also improve a recognition rate in recognizing a speech or audio.

The above-described example embodiments of the audio signal processing method to robust against noise may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments of the present invention, or vice versa.

Although a few example embodiments of the present invention have been shown and described, the present invention is not limited to the described example embodiments. Instead, it would be appreciated by those skilled in the art that changes may be made to these example embodiments without departing from the principles and spirit of the invention, the scope of which is defined by the claims and their equivalents.

Therefore, the scope of the present invention is defined not by the detailed description, but by the claims and their equivalents, and all variations within the scope of the claims and their equivalents are to be construed as being included in the present invention.

What is claimed is:

1. An audio signal processing apparatus, comprising:
a receiver configured to receive a speech and audio signal;
a spectrogram converter configured to convert the speech and audio signal to a spectrogram image;
a gradient calculator configured to calculate, using a mask matrix, a local gradient from the spectrogram image;
a histogram generator configured to divide the local gradient into blocks of a preset size and generate a weighted histogram for each block; and
a feature vector generator configured to generate an audio feature vector by connecting weighted histograms of the blocks.

2. The apparatus of claim 1, further comprising:
a recognizer configured to recognize a speech or audio comprised in the speech and audio signal by comparing the audio feature vector to a feature vector of prestored training data.

3. The apparatus of claim 1, further comprising:
a discrete cosine transformer configured to generate a feature set by performing a discrete cosine transform (DCT) on a feature set of the audio feature vector.

4. The apparatus of claim 3, further comprising:
a recognizer configured to recognize a speech or audio comprised in the speech and audio signal by comparing the transformed feature set to a feature set of prestored training data.

5. The apparatus of claim 3, further comprising:
an optimizer configured to generate an optimized feature set by eliminating an unnecessary region from the transformed feature set and reducing a size of the transformed feature set.

6. The apparatus of claim 5, further comprising:
a recognizer configured to recognize a speech or audio comprised in the speech and audio signal by comparing the optimized feature set to a feature set of prestored training data.

7. The apparatus of claim 1, wherein the spectrogram converter is configured to generate the spectrogram image by performing a discrete Fourier transform (DFT) on the speech and audio signal based on a Mel-scale frequency.

8. A speech and audio signal processing method performed by an audio signal processing apparatus, the method comprising:
receiving a speech and audio signal;
converting the speech and audio signal to a spectrogram image;
calculating, using a mask matrix, a local gradient from the spectrogram image;
dividing the local gradient into blocks of a preset size and generating a weighted histogram for each block; and
generating an audio feature vector by connecting weighted histograms of the blocks.

9. The method of claim 8, further comprising:
recognizing a speech or audio comprised in the speech and audio signal by comparing the audio feature vector to a feature vector of prestored training data.

10. The method of claim 8, further comprising:
generating a feature set by performing a discrete cosine transform (DCT) on a feature set of the audio feature vector.

11. The method of claim 10, further comprising:
recognizing a speech or audio comprised in the speech and audio signal by comparing the transformed feature set to a feature set of prestored training data.

12. The method of claim 10, further comprising:
generating an optimized feature set by eliminating an unnecessary region from the transformed feature set and reducing a size of the transformed feature set.

13. The method of claim 12, further comprising:
recognizing a speech or audio comprised in the speech and audio signal by comparing the optimized feature set to a feature set of prestored training data.

14. The method of claim 8, wherein the converting comprises:
generating the spectrogram image by performing a discrete Fourier transform (DFT) on the speech and audio signal based on a Mel-scale frequency.

15. A speech and audio signal processing method performed by an audio signal processing apparatus, the method comprising:
converting a speech and audio signal to a spectrogram image; and
extracting a feature vector based on a gradient value of the spectrogram image.

16. The method of claim 15, further comprising:
recognizing a speech or audio comprised in the speech and audio signal by comparing the feature vector to a feature vector of prestored training data.
